(19) United States
(12) Patent Application Publication
(10) Pub. No.: US 2016/0200507 A1
(43) Pub. Date: Jul. 14, 2016

(54) EXTENSIBE RECYCLING SYSTEM

(71) Applicant: Rita Danilenko, Pompano Beach, CA (US)

(72) Inventor: Rita Danilenko, Pompano Beach, CA (US)

(21) Appl. No.: 14/993,855

(22) Filed: Jan. 12, 2016

Related U.S. Application Data
(60) Provisional application No. 62/102,120, filed on Jan. 12, 2015.

(51) Int. Cl. B65F 1/00

(52) U.S. Cl. CPC B65F 1/0053; B65F 2210/165

(57) ABSTRACT

Methods and apparatus to an extensible recycling system. A system includes an input device, a Master Control Panel (MCP) unit linked to the input device, a sorting unit linked to the MCP and responsive to one or more signals from the MCP, the sorting unit separating solid waste from recyclables, a solid waste container to receive solid waste from the sorting unit, and a recyclable container to receive recyclables from the sorting unit.

### CROSS REFERENCE TO RELATED APPLICATIONS

This application claims priority to U.S. Provisional Application Serial. No. 62/102,120, filed on Jan. 12, 2015, and entitled “EXTENSIBLE RECYCLING SYSTEM,” the entire contents of which are hereby incorporated by reference.

### BACKGROUND OF THE INVENTION

The present invention generally relates to the collection of waste materials, and more specifically to an extensible recycling system.

In general, in the absence of automation equipment, the collection of disposed recyclables in high-rise residential buildings is both labor-intensive and time consuming because the recyclables often need to be collected individually from each floor by sanitation personnel. Moreover, overall inefficiency of individual floor collection increases with “taller” buildings that have a higher floor count.

### SUMMARY OF THE INVENTION

The following presents a simplified summary of the innovation described herein. This summary is not an extensive overview of the invention. It is intended to neither identify key nor critical elements of the invention nor delineate the scope of the invention. Its sole purpose is to present some concepts of the invention in a simplified form as a prelude to the more detailed description that is presented later.

The present invention generally relates to the collection of waste materials, and more specifically to an extensible recycling system. More specifically, the present invention automates the process of collecting both recyclables and solid waste, particularly in high-rise buildings.

The extensible recycling system of the present invention renders it practical to use a single chute for both solid waste and recyclables while still maintaining separation between two or three categories of waste.

The extensible recycling system of the present invention uses fewer parts and better designed components than all legacy systems, making it of higher quality and easier to install.

A floor control board (FCB) of the extensible recycling system of the present invention supports multiple solenoids.

The extensible recycling system of the present invention can be Internet-enabled.

In one aspect, the invention features a system including an input device, a Master Control Panel (MCP) unit linked to the input device, a sorting unit linked to the MCP and responsive to one or more signals from the MCP, the sorting unit separating solid waste from recyclables, a solid waste container to receive solid waste from the sorting unit, and a recyclable container to receive recyclables from the sorting unit.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The features and advantages of the invention are apparent from the following description taken in conjunction with the accompanying drawings in which:

FIG. 1 illustrates a first implementation of a floor control board (FCB) of the extensible recycling system of the present invention.

FIG. 2 illustrates a second implementation of a FCB of the extensible recycling system of the present invention.

FIG. 3 illustrates placement of a conversion bridge in a Programmable Logic Controller (PLC) of the extensible recycling system of the present invention.

FIG. 4 illustrates an embodiment of the extensible recycling of the present invention that is Internet-enabled.

### DETAILED DESCRIPTION OF THE INVENTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, and so forth, described in one embodiment may also be included in other embodiments, but is not necessarily included. Thus, the present technology can include a variety of combinations and/or integrations of the embodiments described herein.

In general, recycling systems are a category or form of automation equipment. And as with any equipment in this category, a purpose of using such equipment is to reduce human labor as well as the costs associated with human labor. To better understand how a recycling system of the present invention functions and why it contributes to labor and cost savings, the following definitions are used throughout the description to follow.

A “chute” refers to a series of connected segments through which either garbage or recyclables or both can descend vertically by means of gravity. A chute is technically not part of a recycling system as it can function independent of any recycling system.

An “intake door” refers a door that provides access to the chute and thus an ability to dispose of items through the chute. In the context of automated recycling systems, an intake door can be locked and unlocked with a solenoid.

A “chute ventilator” refers to an upper terminus of the chute.

A “chute guillotine” refers to a lower terminus of the chute that remains open during normal circumstances. In the event of a fire that is in close proximity to the chute guillotine, the surrounding heat typically causes a fusible link to melt and subsequently trigger a closure of the chute. This type of mechanism is mandated by fire safety codes.

A “sorting unit” refers to a mechanical portion of the recycling system that performs the sorting. In one example, the sorting unit is in the form of a bi-sorter, i.e., two sorting categories.

A “compactor” refers to a form of equipment that can compress garbage into a smaller volume. The compactor is dependent on a power pack, described below. A compactors and a power packs have reciprocal dependency and thus typically cannot function separately.

A “power pack” refers to a form of equipment that provides hydraulic force to the compactor. It offers no utility as a standalone unit and is therefore dependent on the compactor.

A “recycling bin” refers to a container that is designated for recyclable material.

A “compaction container” refers to a large container, typically large metal container, in which garbage is stored after being compressed by the compactor unit.

A “master control panel” refers to an enclosure that contains the Programmable Logic Controller (PLC) for translation of inputs into outputs, a display screen for rendering a user interface to view status and change parameters, a power button, and a selector switch for changing sort modes. The master control panel is a centralized unit that controls the entire recycling system.

A “floor interface board” refers to a circuit board that is installed on individual floors. Not all recycling systems utilize the floor interface board.

A “floor control board (FCB)” refers to a circuit board that is installed on individual floors. Some recycling systems utilize a floor control board that is smaller and with more capabilities.

A “keypad” refers to a thin and flexible membrane panel with buttons that is installed on each and every floor. The keypad enables users to select a desired disposal category.

A “trashroom” refers to a room, typically on a ground floor, where the master control panel, compactor, power pack, and sorting unit are installed. Although the trashroom is technically not part of a recycling system, it is mentioned and defined here to provide context.

Many residential apartments are typically part of a tall building structure with a large number of floors. In addition to residential apartments, many hotels, government buildings, schools, dormitories, and other structures possess a high number of floors. Therefore, garbage and recyclables generated by occupants will usually descend vertically in order to arrive at the central point for bulk collection on the ground floor. Chutes are hollow cylindrical segments that, when connected together, function as a large tube through which garbage and recyclable waste can travel by gravity from an upper floor down to a trashroom on a ground floor. On each floor, with the exception of the ground floor, there is typically a vestibule designated for garbage disposal. And inside every vestibule there is typically an intake door that provides direct access to the chute. When a building resident desires to throw away his/her garbage, he/she enters the vestibule on his/her apartment floor, opens the intake door to gain access to the chute, and then tosses his/her sealed garbage down the chute. Per fire code regulations, each and every intake door must close independently when the user removes his/her manual force away from a knob or handle on the intake door.

Nearly all buildings possess one chute for disposal purposes. When no recycling system is installed or utilized, the availability of only one chute becomes a serious problem when building management undertakes an initiative to enable the collection of both garbage and recyclables. Without a recycling system, efficient sorting and collection through a single chute is not possible. In many legal jurisdictions, laws and regulations mandate the collection of both waste and recyclables, regardless of the inefficiency and added labor costs involved.

It is inherently inefficient and counterproductive to maintain recycling disposal facilities within hi-rise structures if no automation equipment is present. Without automation equipment, management typically instructs residents to dispose of solid waste down the one and only one chute that is available to them, but recyclables may be disposed of into a separate bin on each floor. Sanitation personnel are then forced to collect the recycling bins on each floor on a one-by-one basis. In these cases, the only method of restoring efficiency and productivity is by installing a recycling system.

Since solid waste (i.e., garbage) and recyclables should not be physically mixed together, manual sorting and collection is required. A recycling system automates the collection and sorting process at the source. At the core of a recycling system is sorting unit (typically referred to as a bi-sorter or a tri-sorter), which separates the solid waste from the recyclables. If the sorting unit is designed to separate disposed items into two categories, then it is known as a bi-sorter. A tri-sorter is capable of separating disposed items into three categories. As solid waste and recyclables descend vertically through a chute, the bi-sorter or tri-sorter unit conducts “sorting” by moving an internal flap so that the disposed item falls into an appropriate container.

Because a recycling system of the present invention, also referred to herein as the Eco Cycle Planet Solution™, renders it practical to use a single chute for both solid waste and recyclables while still maintaining separation between the two or three categories, there is no longer a need for labor-intensive sanitation. There is no reason for maintaining separate recycling bins on each and every floor when the recycling system automates the collection process much more effectively.

One variation of recycling system that is commonly used is referred to as a “legacy” recycling system. Despite using outdated parts and components, legacy recycling systems remain in use. In this legacy system, a bi-sorter or tri-sorter is used depending on customer preferences.

In general, recycling systems include Master Control Panel (MCP) unit that controls all other mechanical and electronic parts by receiving inputs and sending outputs. Within each MCP unit is a Programmable Logic Controller (PLC), a type of device that functions as an industrial computer. PLCs are programmed with software/firmware that instructs how to process numerous electrical inputs into the desired outputs.

In these prior recycling systems, there is no mechanism to automatically discern between garbage and recyclables—it's upon the building occupants to “tell” the system by pressing a button. These buttons are part of a membrane keypad that is typically affixed directly above the intake door. When a user desires to dispose garbage, he/she presses the appropriate button on the keypad. In another example, if the user desires to dispose of recyclables, then he/she would press a different button that corresponds to recyclable materials (e.g., newspapers, glass, plastic, and so forth).

Upon pressing any button on the keypad, a signal is sent to the MCP through a communication cable. The MCP, and more specifically the PLC, processes this input from a particular floor and activates the bi-sorter or tri-sorter, whose internal flap(s) move to the appropriate position so that the disposed item can fall into the correct container. Once the bi-sorter or tri-sorter is ready for the item about to be dropped, the intake door is unlocked by a solenoid. The user opens the door by pulling on the handle, drops his/her item for disposal, and releases his/her hand away from the door's handle. The intake door closes independently, in the absence of manual force. At the same time, the disposed item lands in the appropriate bin. The bi-sorter or tri-sorter then becomes ready for the next cycle.

The above summarizes the steps that occur in one cycle. The extensible recycling system of the present invention uses fewer parts and better designed components than all legacy systems, making it of higher quality and easier to install due to the fewer parts.

Utilization of fewer components to achieve the same result is most evident in the infrastructure that links individual floors to the MCP. Every floor must have a means of sending and receiving signals from the MCP. Legacy recycling systems use these components for linking floors to the MCP:

Floor Control Board (FCB), with support for 24 VDC only.

Floor Interface Board (FIB).

14-Pin Ribbon Cable, for linking of FCB to FIB.

Membrane Keypads, connected via an 18-pin ribbon cable to the FCB.

Solenoid, an electro-magnetic mechanism for locking and unlocking the door, is connected to the FCB.

The above list describes all the parts necessary to link the floors on a legacy recycling system's RS-422 communication network.

The extensible recycling system of the present invention uses the following components for linking floors to the MCP:

Floor Control Board (FCB), with both 24 VDC and 120 VAC support.

Membrane Keypads, connected via a 10 or 8-pin ribbon cable to the FCB.

Solenoid, an electro-magnetic mechanism for locking and unlocking the door, is connected to the FCB.

The extensible recycling system of the present invention is better for both economical and practical reasons. It's economical because fewer parts are used. And it's practical because it's easier to install. The design of legacy systems necessitates good skills and experience to properly install, but is counter-intuitive regardless, due to the complexity. The extensible recycling system of the present invention is simpler, which enables easier installation. Advanced skills and experience are not required to properly install or service floor components designed for the extensible recycling system of the present invention.

Another difference between the legacy systems and the extensible recycling system of the present invention is the PLC that is used. In legacy recycling systems, obsolete PLCs from OMRON Corporation are still being used. Despite the widespread marketshare of legacy recycling systems, obsolete OMRON™ PLCs continue to be installed in every new MCP unit that is manufactured. In stark contrast, the MCPs of the present invention use a combined display and controller unit. The controller is the latest iteration available today and the display is a high-resolution, color, touchscreen display. There are no obscure function buttons, the user only has to interact with the user interface (UI) displayed on the touchscreen.

Other features of the extensible recycling system of the present invention include the following:

An innovative multi-function PLC that doubles as a touchscreen display is used. Because the PLC and touchscreen display are integrated into a single unit, this reduces space, making it possible to use a smaller MCP enclosure.

An Eco Cycle Planet Solution™ MCP enclosure is smaller than the legacy MCP enclosures. Less space is needed to perform the same tasks.

Floor Control Boards (FCBs) can be used both on individual floors and within the MCP. The Eco Cycle Planet Solution™ FCB is smaller and it can easily function within the MCP. A dedicated MCB is not required.

The display and PLC function as a single unit. The display renders output in high-resolution and full color. It can also receive touch input; hence, it is unnecessary to include function buttons. Due to these characteristics, it is easier to implement a user friendly UI that is intuitive and easy to understand.

FCBs in Eco Cycle Planet Solution™ recycling systems are relatively smaller in size and more versatile. More importantly, these FCBs can support a single solenoid operating at either 24 VDC or 120 VAC.

In legacy systems, chutes are not hermetically sealed and some individuals may be sensitive to bad odors. Allergies, respiratory diseases, and other pre-existing health conditions may cause further discomfort if the affected individual comes into close contact with bad odors. In response to this problem, in embodiments, the extensible recycling system of the present invention uses an enhanced odor control system that can help neutralize the bad odors.

Legacy odor control systems release sanitizing mist according to a fixed frequency set by a timer control. A major limitation is that fixed frequency does not coincide with when residents open the intake doors to dispose of their waste. The timer device that is attached to the odor control unit cannot discern when intake doors are opened. The extensible recycling system of the present invention links odor control units directly into the MCP units. This enables the release of odor neutralizing mist immediately upon the disposal of garbage from the top floors. In one embodiment, the extensible recycling system of the present invention uses an odor control solution of “organic” substances that neutralize odors.

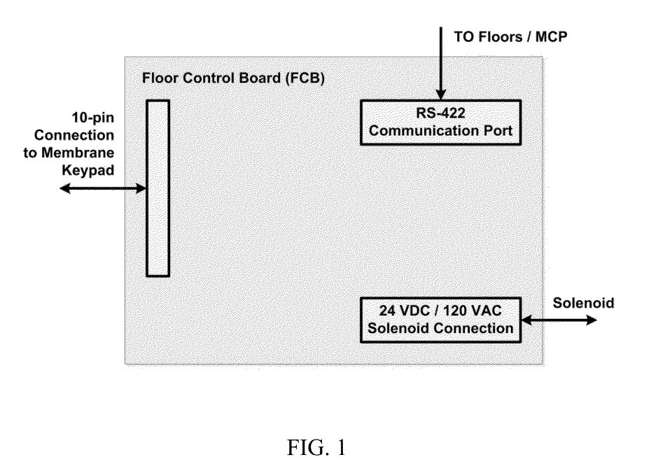

FIG. 1 illustrates a first implementation of a FCB of the extensible recycling system of the present invention.

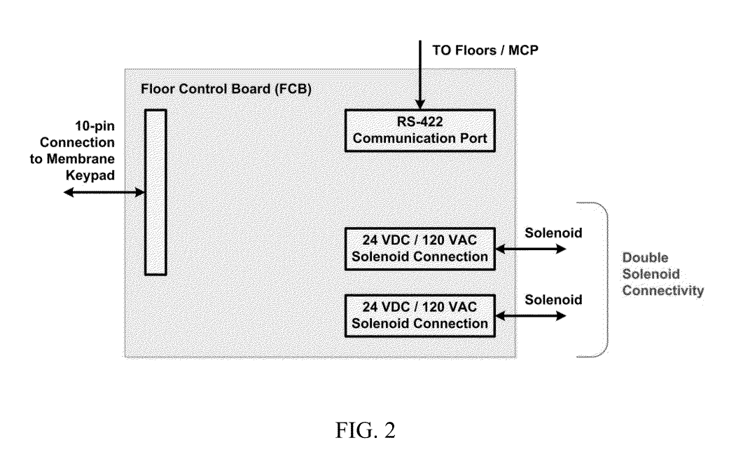

FIG. 2 illustrates a second of a FCB of the extensible recycling system of the present invention that supports two solenoids. Double solenoid connectivity gives the advantage of greater extensibility.

One solenoid is sufficient for controlling an intake door, but a second solenoid opens the possibility of further extending the system (e.g., according to customer preferences) to better meet ancillary goals, such as sprinkler or fire suppression systems. By implementing a second solenoid connection, Eco Cycle Planet Solution™ FCBs can be attached to any external medium that needs a solenoid.

PLCs can be programmed with ladder-logic but this form of programming is incompatible with non-industrial applications and create an impediment toward extensibility and integration. In one embodiment, the extensible recycling system of the present invention incorporates a “conversion bridge,” a type of interface that can translate input/output (I/O) between the PLC and the PC-based hardware that is connected to the internet via Wi-Fi (wireless) or Ethernet (wired connection). This conversion bridge on one end connects to a USB port on the other end and uses wiring to the PLC unit.

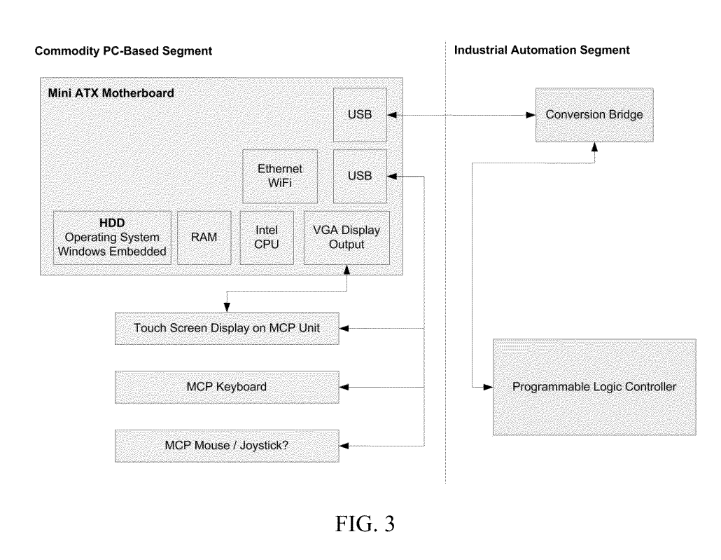

FIG. 3 illustrates placement of a conversion bridge in a PLC of the extensible recycling system of the present invention.

With Microsoft Windows® embedded as an operating system, or any other operating system capable to be embedded into the device, the information sharing functions of the extensible recycling system of the present invention is extended. Windows® applications can be written or modified to interact with the Eco Cycle Planet Solution™ system and insure sharing of information with internet connectivity.

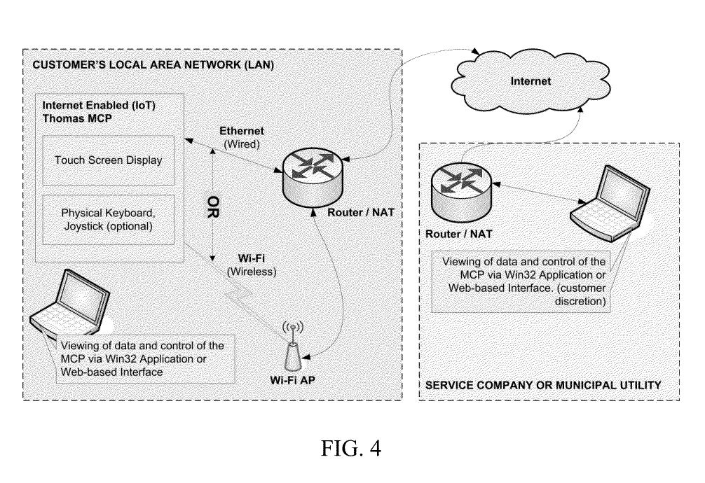

FIG. 4 illustrates an embodiment of the extensible recycling system of the present invention that is Internet-enabled.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices, magnetic disks, e.g., internal hard disks or removable disks, magneto optical disks, and CD ROM and DVD-ROM disks. The processor and the memory can be supplemented by, or incorporated in special purpose logic circuitry.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here.

What is claimed is:

1. A system comprising:
an input device;
a Master Control Panel (MCP) unit linked to the input device;
a sorting unit linked to the MCP and responsive to one or more signals from the MCP, the sorting unit separating solid waste from recyclables;
a solid waste container to receive solid waste from the sorting unit; and
a recyclable container to receive recyclables from the sorting unit.

2. The system of claim 1 wherein the input device is a keypad.

3. The system of claim 1 wherein the sorting unit include one or more internal flaps that move to an appropriate position in response to the received signal so that a disposed item can fall into either the solid waste container or the recyclable container.
